(19) United States
(12) Patent Application Publication
(10) Pub. No.: US 2025/0175321 A1
(43) Pub. Date: May 29, 2025

(54) METHOD FOR MONITORING NETWORK USING HOMOMORPHIC ENCRYPTION AND ELECTRONIC APPARATUS

(71) Applicant: CRYPTO LAB INC., Seoul (KR)

(72) Inventors: Jeongdae Hong, Seoul (KR); Seon-Min Hong, Yongin-si (KR)

(21) Appl. No.: 18/959,049

(22) Filed: Nov. 25, 2024

(30) Foreign Application Priority Data
Nov. 24, 2023 (KR) 10-2023-0165388

(51) Int. Cl. H04L 9/00; H04L 9/40

(52) U.S. Cl. CPC H04L 9/008; H04L 63/0428

(57) ABSTRACT

An electronic apparatus includes: a communication device connected to a network; a memory for storing a public key generated using a homomorphic encryption method and an evaluation key used for an homomorphic operation; and a processor configured to generate second encrypted data by using first encrypted data, the public key, and a key switching method if the first encrypted data transmitted and received through the network is acquired through the communication device, and check whether the first encrypted data includes predetermined information by performing the homomorphic operation, which corresponds to a predetermined detection function, on the generated second encrypted data.

### TECHNICAL FIELD

The present disclosure relates to a method for monitoring a network using homomorphic encryption and an electronic apparatus, and more particularly, to a method for monitoring a network using homomorphic encryption to check whether encrypted data includes information that violates a security matter by using key switching on the corresponding encrypted data transmitted and received in the network, and an electronic apparatus.

### BACKGROUND ART

In accordance with the development of communication technology and a growing spread of electronic apparatuses, efforts are continuously being made to maintain communication security between the electronic apparatuses. Accordingly, encryption/decryption technology is used in most communication environments.

However, all data may be encrypted and transmitted and received to prevent technology leaks. In this case, it is impossible to check what kind of material is included in the encrypted data before decrypting the corresponding data. Therefore, it is difficult to distinguish whether the transmitted data is general data or a confidential document that is prohibited from being sent externally.

Measures such as blocking transmission to an external internet protocol (IP) address and the like may be used to prevent such technology leaks. However, in this case, there is also the possibility of using a bypass method, such as transmitting a file from an internal network to a device like a mobile phone, and then transmitting this file to a separate network through the mobile phone. Therefore, a method is required to monitor whether the material requiring security, or similar, as described above, has leaked during a communication process, not only through the external network but also through the internal network.

### Technical Solution

The present disclosure provides a method for monitoring a network to check whether encrypted data includes information that violates a security matter by using key switching on the corresponding encrypted data transmitted and received in a network, and an electronic apparatus.

According to an embodiment of the present disclosure, provided is an electronic apparatus including: a communication device connected to a network; a memory for storing a public key generated using a homomorphic encryption method and an evaluation key used for an homomorphic operation; and a processor configured to generate second encrypted data by using first encrypted data, the public key, and a key switching method if the first encrypted data transmitted and received through the network is acquired through the communication device, and check whether the first encrypted data includes predetermined information by performing the homomorphic operation, which corresponds to a predetermined detection function, on the generated second encrypted data.

The processor may be configured to acquire the first encrypted data and a session key ciphertext, which is generated by homomorphically encrypting a session key used for encrypting the first encrypted data, the session key ciphertext being generated by homomorphically encrypting the session key using the public key, and use the key switching method to generate the second encrypted data capable of being decrypted using a secret key corresponding to the public key by using the session key which is a decryption key for the first encrypted data.

The first encrypted data may be data encrypted using a derived public key that is generated by calculating the public key and a session key, and the processor may be configured to acquire the first encrypted data and a session key ciphertext, which is generated by homomorphically encrypting the session key using the public key, and uses the key switching method to generate the second encrypted data capable of being decrypted using a secret key corresponding to the public key by using the derived public key which is a decryption key for the first encrypted data.

The first encrypted data may be data encrypted using a symmetric key method, and the second encrypted data may be data homomorphically encrypted using a public key method.

The processor may be configured to control the communication device to transmit a homomorphic ciphertext, on which the homomorphic operation is performed, to an external device having a secret key corresponding to the public key, and check whether the first encrypted data includes the predetermined information based on a verification result notified by the external device.

The processor may be configured to control the communication device to transmit the first encrypted data to the external device based on the verification result notified by the external device, and verify the inclusion of the predetermined information by using plaintext data decrypted by the external device.

The processor may be configured to check whether the first encrypted data includes the predetermined information in the encrypted data transmitted to an internet protocol (IP) address other than a predetermined IP address in case of acquiring sender IP address information and receiver IP address information, corresponding to the first encrypted data.

According to an embodiment of the present disclosure, provided is a method for monitoring a network by an electronic apparatus, the method including: pre-storing a public key generated using a homomorphic encryption method and an evaluation key used for an homomorphic operation; acquiring first encrypted data transmitted and received through the network; generating second encrypted data by using the first encrypted data, the public key, and a key switching method; and checking whether the first encrypted data includes predetermined information by performing the homomorphic operation, which corresponds to a predetermined detection function, on the generated second encrypted data.

In the acquiring, the first encrypted data and a session key ciphertext, which is generated by homomorphically encrypting a session key used for encrypting the first encrypted data, may be acquired, the session key ciphertext being generated by homomorphically encrypting the session key using the public key, and in the generating of the second encrypted data, the key switching method may be used to generate the second encrypted data capable of being decrypted using a secret key corresponding to the public key by using the session key which is a decryption key for the first encrypted data.

The first encrypted data may be data encrypted using a derived public key that is generated by calculating the public key and a session key, in the acquiring, the first encrypted data and a session key ciphertext, which is generated by homomorphically encrypting the session key using the public key, may be acquired, and in the generating of the second encrypted data, the key switching method may be used to generate the second encrypted data capable of being decrypted using a secret key corresponding to the public key by using the derived public key which is a decryption key for the first encrypted data.

The first encrypted data may be data encrypted using a symmetric key method, and the second encrypted data may be data homomorphically encrypted using a public key method.

In the checking, a homomorphic ciphertext, on which the homomorphic operation is performed, may be transmitted to an external device having a secret key corresponding to the public key, and whether the first encrypted data includes the predetermined information may be checked based on a verification result notified by the external device.

The method may further include: transmitting the first encrypted data to the external device based on the verification result notified by the external device; and verifying the inclusion of the predetermined information by using plaintext data decrypted by the external device.

In the acquiring, sender IP address information and receiver IP address information, corresponding to the first encrypted data, may be acquired, and in the generating of the second encrypted data, whether the first encrypted data includes the predetermined information may be checked in the encrypted data transmitted to an internet protocol (IP) address other than a predetermined IP address.

According to an embodiment of the present disclosure, provided is a computer-readable recording medium storing a program for executing a method for monitoring a network by an electronic apparatus, wherein the method includes pre-storing a public key generated using a homomorphic encryption method and an evaluation key used for an homomorphic operation, acquiring first encrypted data transmitted and received through the network, generating second encrypted data by using the first encrypted data, the public key, and a key switching method, and checking whether the first encrypted data includes predetermined information by performing the homomorphic operation, which corresponds to a predetermined detection function, on the generated second encrypted data.

According to the various embodiments of the present disclosure as described above, it is possible to check whether the security breach occurs on the corresponding data even without performing the decryption process on the encrypted data.

### DESCRIPTION OF DRAWINGS

FIG. 1 is a diagram for explaining a structure of a network system according to an embodiment of the present disclosure;

FIG. 2 is a block diagram showing a brief configuration of an electronic apparatus according to an embodiment of the present disclosure;

FIG. 3 is a block diagram showing a detailed configuration of the electronic apparatus according to an embodiment of the present disclosure;

FIG. 4 is a diagram for explaining a monitoring method according to a first embodiment of the present disclosure;

FIG. 5 is a diagram for explaining a monitoring method according to a second embodiment of the present disclosure;

FIG. 6 is a diagram for explaining a monitoring method according to a third embodiment of the present disclosure; and

FIG. 7 is a diagram for explaining the monitoring method according to an embodiment of the present disclosure.

### DETAILED DESCRIPTION

Hereinafter, the present disclosure is described in detail with reference to the accompanying drawings. Encryption/decryption may be applied as necessary to a process of transmitting information (or data) that is performed in the present disclosure, and an expression describing the process of transmitting the information (or data) in the present disclosure and the claims should be interpreted as also including cases of encrypting/decrypting the information (or data) even if not separately mentioned. In the present disclosure, an expression such as “transmission (transfer) from A to B” or “reception from A to B” may include transmission (transfer) or reception while having another medium included in the middle, and may not necessarily express only the direct transmission (transfer) or reception from A to B.

In describing the present disclosure, a sequence of each operation should be understood as non-restrictive unless a preceding operation in the sequence of each operation needs to logically and temporally precede a subsequent operation. That is, except for the above exceptional case, the essence of the present disclosure is not affected even in case that a process described as the subsequent operation is performed before a process described as the preceding operation, and the scope of the present disclosure should also be defined regardless of the sequences of the operations. In addition, in the specification, “A or B” may be defined to indicate not only selectively indicating either one of A and B, but also including both A and B. In addition, a term “including” in the present disclosure may have a meaning encompassing further including other components in addition to components listed as being included.

The present disclosure only describes essential components necessary for describing the present disclosure, and does not mention components unrelated to the essence of the present disclosure. In addition, it should not be interpreted as an exclusive meaning that the present disclosure includes only the mentioned components, and should be interpreted as a non-exclusive meaning that the present disclosure may include other components as well.

In addition, in the present disclosure, a “value” may be defined as a concept that includes a vector as well as a scalar value. In addition, in the present disclosure, an expression such as “calculate” or “compute” may be replaced with an expression of generating a result of the corresponding calculation or computation. In addition, unless otherwise specified, an operation on a ciphertext described below indicates a homomorphic operation. For example, addition of homomorphic ciphertexts indicates homomorphic addition for the two homomorphic ciphertexts.

Mathematical operations and calculations in each step of the present disclosure described below may be implemented as computer operations by a known coding method and/or coding designed to be suitable for the present disclosure to perform the corresponding operations or calculations.

Specific equations described below are illustratively described among possible alternatives, and the scope of the present disclosure should not be construed as being limited to the equations mentioned in the present disclosure.

For convenience of description, the present disclosure defines the following notations:
a←D: Select an element “a” based on distribution “D”.
s₁, s₂∈R: Each of s₁ and s₂ is an element belonging to a set “R”.
mod(q): Perform modular operation with an element “q”.
[·]: Round an internal value.

Hereinafter, various embodiments of the present disclosure are described in detail with reference to the accompanying drawings.

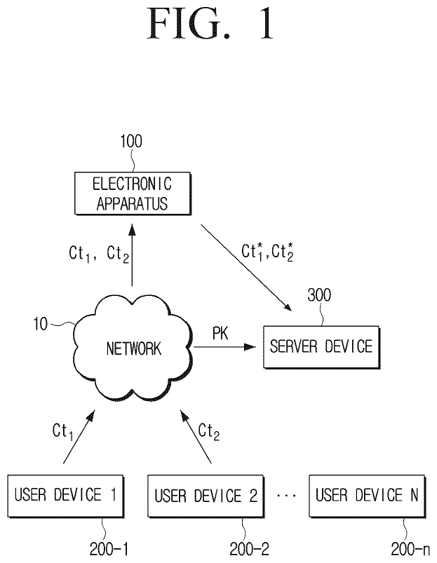

FIG. 1 is a diagram for explaining a structure of a network system according to an embodiment of the present disclosure.

Referring to FIG. 1, the network system may include an electronic apparatus 100, a plurality of user devices 200-1 to 200-n, and a server device 300, and the respective components may be connected to each other through a network 10.

The networks 10 may be implemented in various types of wired and wireless communication networks, broadcast communication networks, optical communication networks, cloud networks, and the like, and the respective apparatuses/devices may be connected to each other in a way such as wireless-fidelity (Wi-Fi), Bluetooth, or near field communication (NFC) without a separate medium.

The user devices 200-1 to 200-n may transmit and receive data through the network 10. Here, the user devices 200-1 to 200-n may transmit and receive the data by using encrypted data, which is processed through encryption, to ensure data security.

Although FIG. 1 shows the plurality of user devices 200-1 to 200-n, the plurality of user devices are not necessarily used, and one device may be used. For example, the user devices 200-1 to 200-n may be implemented in various types of devices such as smartphones, tablets, game players, personal computers (PCs), laptop PCs, home servers, and kiosks, and may also be implemented in other types of home appliances each having an Internet of things (IoT) functions.

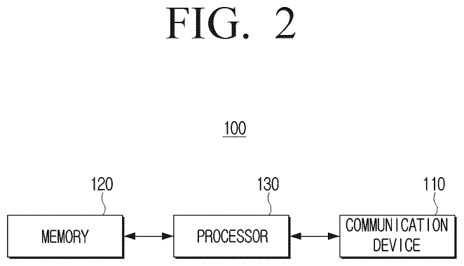

The server device 300 may generate a secret key, a public key, an evaluation key, or the like, used for the homomorphic ciphertext, provide the public key and the evaluation key to the electronic apparatus 100, and provide the public key to each of the user devices. A detailed key generation operation is described below with reference to FIG. 2.

In addition, the server device 300 may decrypt the homomorphic ciphertext provided from the outside by using the secret key that is prestored therein, and may provide a decryption result to the electronic apparatus 100. This server device 300 may perform key generation and thus be referred to as a key generation device, and may perform a decryption operation and thus also be referred to as a decryption device. The server device 300 may be implemented as a server, a computer, the laptop PC, or the like.

The electronic apparatus 100 may monitor the data transmitted and received through the network 10. In detail, the electronic apparatus 100 may monitor the data transmitted and received by the user devices 200-1 to 200-n using the network 10. Here, the transmitted and received data may be data encrypted using a predetermined key.

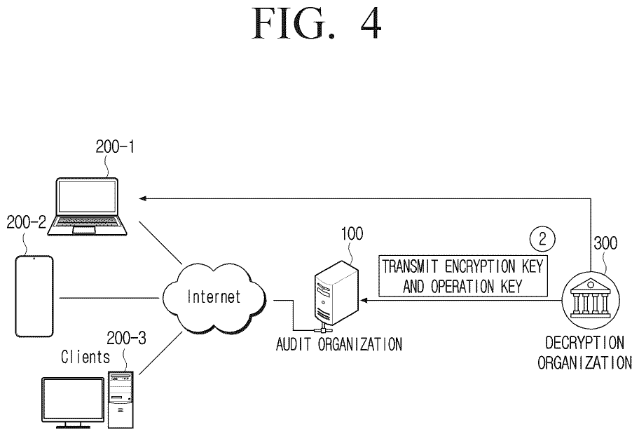

The electronic apparatus 100 may convert the encrypted data acquired using a key switching method into the homomorphic ciphertext decrypted using the secret key. Here, the key switching method is a method of changing the secret key used to decrypt the ciphertext, and may change not only the secret key but also an encryption method while maintaining an encryption system. For example, the present disclosure assumes a case where the ciphertext encrypted by a symmetric key method using a first secret key is converted into the homomorphic ciphertext in a public key format that may be decrypted using a second secret key. However, the present disclosure may adopt various methods other than the above-described methods. Details of the key switching method are described with reference to FIG. 4.

In addition, the electronic apparatus 100 may check whether the corresponding encrypted data violates the security by performing a predetermined homomorphic operation on the converted homomorphic ciphertext.

In detail, the electronic apparatus 100 may perform a homomorphic operation to detect whether the converted homomorphic ciphertext includes a predetermined keyword (for example, a homomorphic operation to detect inclusion of a keyword such as “security” or “confidential”, a homomorphic operation to detect a file format of a predetermined type (for example, a drawing file or an image file), or a homomorphic operation to detect that a file creator is different from a user who sends the data). A specific example of the homomorphic operation is described below with reference to FIG. 4.

The homomorphic ciphertext on which the homomorphic operation is performed may be transmitted to the server device 300. The server device 300 may decrypt the received homomorphic ciphertext by using the secret key, and transmit the decryption result to the electronic apparatus 100. Here, the decryption result may have “1” if specific content is detected, and “0” if the specific content is not detected.

The electronic apparatus 100 may detect whether the corresponding data violates the security based on the decryption result of the server device 300, and perform verification on the corresponding data if the security violation is detected. For example, the electronic apparatus 100 may transmit the homomorphic ciphertext to the server device 300 before the homomorphic operation, and the server device 300 may decrypt the data transmitted from the user devices by decrypting the homomorphic ciphertext.

The electronic apparatus 100 may be the server device, a computer device, the laptop, or a network device such as a switching hub, a wireless router, or a router.

Meanwhile, an example in the drawing shows that the electronic apparatus 100, the user devices 200-1 to 200-n, and the server device 300 use one network 10. However, the electronic apparatus 100 may use a plurality of networks. For example, the network described above may be an internal network within a company, government office, or the like.

In addition, the electronic apparatus 100 and the server device 300 may be connected to each other through a separate external network or dedicated network. In this case, the electronic apparatus 100 may receive and acquire the public key and the evaluation key through the server device 300, and provide the acquired public key to the user devices 200-1 to 200-n.

Meanwhile, as described above, only the server device 300 may possess and use the secret key. Therefore, other devices except for the electronic apparatus 100 and a device that transmits and receives the data may have difficulty in decrypting the data. As described above, in the present disclosure, it is possible to monitor whether the corresponding data violates the security, or the like even in a case of transmitting and receiving the data in the encrypted state.

FIG. 2 is a block diagram showing a brief configuration of the electronic apparatus according to an embodiment of the present disclosure.

Referring to FIG. 2, the electronic apparatus 100 may include a communication device 110, a memory 120, and a processor 130. Meanwhile, the electronic apparatus 100 in the present disclosure may basically perform the function of the electronic apparatus 100 in FIG. 1, and the user device 200 in FIG. 1 may also perform the function of the server device 300.

The communication device 110 may connect the electronic apparatus 100 to an external device (not shown), and may be connected to the external device through a local area network (LAN) or the Internet network or through a universal serial bus (USB) port or a wireless communication (for example, wireless fidelity (WiFi) 802.11a/b/g/n, near field communication (NFC), or Bluetooth) port. The communication device 110 may also be referred to as a transceiver.

The communication device 110 may receive the public key and the evaluation key from the server device 300, and transmit the received public key to the user device 200.

The communication device 110 may receive the encrypted data in a first manner, and transmit the encrypted data in a second manner generated through an operation described below. Here, the first manner may be the encryption method based on the symmetric key method, and the second manner may be the homomorphic encryption method based on the public key. In addition, the encryption in the first manner described above may be performed using a session key, and the encrypted data may be generated using a derived public key that is generated by calculating the public key and the session key. The detailed encryption method is described below with reference to FIGS. 4 to 6.

The communication device 110 may receive the decryption result from the server device 300.

Meanwhile, if the electronic apparatus 100 performs a key generation function used for the homomorphic ciphertext, the communication device 110 may transmit the generated public key and evaluation key to another device, receive the homomorphic ciphertext from another device, and provide the decryption result of the received homomorphic ciphertext to another device that transmitted the homomorphic ciphertext.

The memory 120 may be a component for storing various instructions and/or software, data, or the like, related to an operating system (O/S) for driving the electronic apparatus 100 or the key switching, the predetermined homomorphic operation, and the generation and operation processing of the homomorphic ciphertext, as described below. The memory 120 may be implemented in various forms such as a random access memory (RAM), read-only memory (ROM), a flash memory, a hard disk drive (HDD), an external memory, or a memory card, and is not limited to any one of these forms.

The memory 120 may store the received data. Here, the data may be transmitted and received through the network.

The memory 120 may store the public key and the evaluation key. Here, the public key is a key used for the homomorphic encryption of a message, and the evaluation key is a key used for the operation of the homomorphic ciphertext. The public key and the evaluation key may be generated based on the secret key.

If the electronic apparatus 100 directly generates the public key, the memory 120 may store not only the secret key but also various parameters necessary for generating the public key and the secret key.

The memory 120 may store the homomorphic ciphertext generated in a process described below.

The processor 130 may control each component in the electronic apparatus 100. The processor 130 may include one device such as a central processing unit (CPU) or an application-specific integrated circuit (ASIC), or may include a plurality of devices such as the CPU and a graphics processing unit (GPU).

The processor 130 may store received public key and evaluation key in the memory 120 in case of receiving the public key and the evaluation key through the communication device 110.

The processor 130 may acquire first encrypted data transmitted and received using the communication device 110 and through the network. In detail, the electronic apparatus 100 may be connected to the network, and the processor 130 may acquire the encrypted data by using the data transmitted and received through the network. Here, the processor 130 may acquire all the data transmitted and received through the network, or may acquire only the encrypted data for data that meets a predetermined condition, such as data transmitted from a specific IP address, data transmitted to the specific IP address, or data of a predetermined size or more.

Here, the acquired encrypted data may be data transmitted or received by the user device, and may be data encrypted using the session key. The detailed encryption method of the encrypted data may be described below with reference to FIGS. 4 to 6.

The processor 130 may generate (or convert) the acquired first encrypted data as (into) second encrypted data. In detail, the processor 130 may use the key switching method to convert the first encrypted data encrypted using the session key into the second encrypted data capable of being decrypted using the secret key used for decrypting the homomorphic ciphertext. For example, the processor 130 may use the key switching method to generate the second encrypted data capable of being decrypted using the secret key corresponding to the public key by using the session key which is a decryption key for the first encrypted data, or may use the key switching method to generate the second encrypted data capable of being decrypted using the secret key corresponding to the public key by using the derived public key which is the decryption key for the first encrypted data.

The processor 130 may perform the predetermined homomorphic operation on the second encrypted data (that is, the homomorphic ciphertext). Here, the homomorphic operation may be the homomorphic operation to detect whether predetermined information is included in the data, and may include, for example, the operation to detect the inclusion of the predetermined keyword (e.g., “security” or “confidential”), the inclusion of data in the predetermined file format (e.g., drawing data), the inclusion of data of the predetermined size or more, or whether the data sender matches the user who wrote the included data. Meanwhile, the homomorphic operation described above may be performed on one of the detection items described above, and also be performed on the plurality of detection items described above.

The homomorphic operation may have an operation algorithm that outputs a decryption result value as “1” if the above-described items are detected, and outputs the decryption result value as “0” if not. Alternatively, if the plurality of items are checked simultaneously, the decryption result value may have a numeric value corresponding to the number of detected items. For example, the decryption result value may have the value of “0” if none of the plurality of items violates anything, and have a result value corresponding to the number corresponding to a violation item or the number of violation items if there is any violation item.

The processor 130 may control the communication device 110 to transmit a homomorphic operation result to the server device 300. In addition, the processor 130 may check whether the predetermined information is included (or whether the security violation occurs) using response data (in detail, the decryption result) received from the server device 300.

Meanwhile, hereinabove, the server device 300 is described as receiving the decryption result and checking whether final violation occurs based on its reception result. However, the server device 300 may receive and process the data, and transmit response information to the electronic apparatus 100 only if the violation item is included in the data.

In this case, the processor 130 may determine that no abnormality occurs if no response is received within a predetermined time after transmitting the homomorphic operation result described above. Conversely, the processor 130 may determine that the security violation occurs if the response is received within the predetermined time.

The processor 130 may confirm the violation through the checking described above. However, the processor 130 may control the communication device to transmit the data before the operation of the homomorphic ciphertext (that is, the homomorphic ciphertext before the predetermined homomorphic operation is performed thereon) to the server device 300 for the verification if the server device 300 returns the result value indicating that the violation item or the predetermined information is included in the data.

The processor 130 may also determine whether the final violation occurs using the received decryption result of the homomorphic ciphertext. Meanwhile, in implementation, this final verification may be performed by the server device 300, not by the electronic apparatus 100. That is, the server device 300 may directly check the decryption result without transmitting the same to the electronic apparatus 100, and provide only a verification result to the electronic apparatus 100.

Here, in case of receiving the response that the predetermined information is included in the data, the electronic apparatus may transmit the first encrypted data to the external device, and use plaintext data decrypted by the external device to thus verify the inclusion of the predetermined information.

As described above, in a method for monitoring a network according to this embodiment, the security violation situation or the like may be detected without performing the direct decryption on the transmitted and received data. In addition, the data in the encrypted state may be transmitted and received through the network in the above-described monitoring process, thus preventing the encrypted data from being disclosed. In addition, the electronic apparatus for the monitoring described above may also be operated without having the secret key for decrypting the homomorphic ciphertext, thus maintaining the security.

Meanwhile, hereinabove, it is described that the homomorphic operation is performed, the result is transmitted to the external server device, and whether the final security violation occurs is determined based on the decryption result received from the external server device. However, in implementation, the homomorphic operation described above may be replaced with a function code.

In detail, the processor 130 may convert the received ciphertext into data applicable to the function code, and apply the converted data to the function code to thus immediately check the inclusion of the violation item.

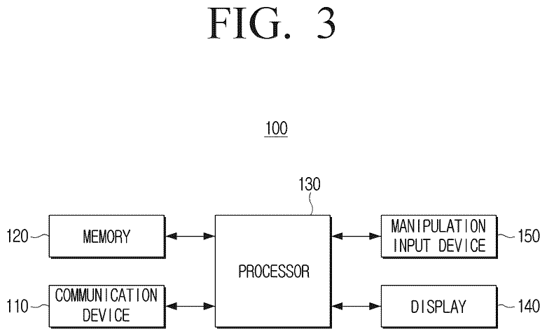

Meanwhile, hereinabove, the description shows and describes only the brief configuration of the electronic apparatus 100. However, in implementation, various configurations may be further provided. This configuration may be described below with reference to FIG. 3.

FIG. 3 is a block diagram showing a detailed configuration of the electronic apparatus according to an embodiment of the present disclosure.

Referring to FIG. 3, the electronic apparatus 100 of the present disclosure may include the communication device 110, the memory 120, the processor 130, a display 140, and a manipulation input device 150.

The communication device 110, the memory 120, and the processor 130 are described above with respect to FIG. 2, and their redundant descriptions are thus omitted. Hereinafter, the description describes only other functions or other operations not described with reference to FIG. 2.

In addition, only the case where the electronic apparatus 100 performs the monitoring operation is described with reference to FIG. 2, and hereinafter, it is described assuming that the electronic apparatus 100 may also generate the key, generate the homomorphic ciphertext, or perform the decryption operation on the homomorphic ciphertext.

The display 140 may display a user interface window for selection of a function supported by the electronic apparatus 100. In detail, the display 140 may display the user interface window for selection of various functions provided by the electronic apparatus 100. The display 140 may be a monitor such as a liquid crystal display (LCD), a cathode ray tube (CRT), or an organic light-emitting diode (OLED), and may also be implemented as a touch screen which may simultaneously perform a function of the manipulation input device 150.

The display 140 may display a message requesting an input of the parameter necessary for generating the secret key or the public key. In addition, the display 140 may display a message for selecting a message that is a target to be encrypted. Meanwhile, in implementation, the encryption target may be directly selected by the user or automatically selected. That is, personal information that requires the encryption may be automatically set even though the user does not directly select the message.

The manipulation input apparatus 150 may receive, from the user, selection of a function of the electronic apparatus 100 and a control command for the corresponding function. In detail, the manipulation input device 150 may receive, from the user, the parameter necessary for generating the secret key or the public key. In addition, the manipulation input device 150 may receive the message to be encrypted from the user.

Meanwhile, the homomorphic ciphertext used in the present disclosure as described above may include encryption noise, that is, an error, in the ciphertext. In detail, the homomorphic ciphertext may be generated in a form that restores the result value including the message and an error value in case of being decrypted later using the secret key. As an example, the homomorphic ciphertext may be generated in a form that satisfies the following properties in case of being decrypted using the secret key.

$$Dec ( ct , sk ) = < c t , sk >= M + e ( mod q ) \qquad [ Equation 1 ]$$

Here, < and > indicate dot product operation (or usual inner product), ct indicates the ciphertext, sk indicates the secret key, M indicates a plaintext message, e indicates an encryption error value, and mod q indicates a modulus of the ciphertext. q needs to be chosen to be larger than the result value M multiplied by a scaling factor Δ to the message. If an absolute value of the error value e is sufficiently smaller than M, a decryption value M+e of the ciphertext may be a value that may replace an original message by the same precision in significant figure operation. Among decrypted data, the error may be disposed on the least significant bit (LSB) side, and M may be disposed on the next least significant bit side.

If a size of the message is too small or too large, the size may be adjusted using the scaling factor. If the scaling factor is used, not only a message in an integer form but also a message in a real number form may be encrypted, and its usability may thus be greatly increased. In addition, the size of the message may be adjusted using the scaling factor to thus also adjust a size of an effective region, that is, a region where the messages exist in the ciphertext after the operation is performed.

In some embodiments, the modulus q of the ciphertext may be set and used in various forms. As an example, the modulus of the ciphertext may be set to a power of 2 or product of coprime primes similar size to the scaling factor Δ

The processor 130 may generate a set parameter based on the received parameter in case of receiving, from the user, the parameter necessary for generating the secret key or the public key, and generate the secret key or the public key based on the generated set parameter.

In detail, the processor 130 may generate the public key by using a ring learning with errors (Ring-LWE) scheme. In detail, the processor 130 may first set various parameters and rings and store the same in the memory 120. An example of the parameter may include the bit length, dimension N, or rank k of the plaintext message, sizes of the public key and the secret key, or the like. The homomorphic ciphertext may have various formats, and the processor 130 may set the ring based on a ciphertext method set by the user or a predetermined method. For example, the homomorphic ciphertext method described above may be a Cheon-Kim-Kim-Song (CKKS) scheme, the ring learning with errors (RLWE) scheme, or the like. The homomorphic ciphertext method may use another scheme other than the above-described schemes.

The ring may be expressed by the following equation.

$$R = {Z}_{q} [ X ] / f ( x ) \qquad [ Equation 2 ]$$

Here, R indicates the ring, Z_{q} indicates a coefficient, and f(x) indicates an N-th polynomial.

The ring indicates a set of polynomials having predetermined coefficients, and indicates the set in which addition and multiplication are defined between elements and which is closed under the addition and the multiplication. The ring may be referred to as Ring.

As an example, the ring indicates a set of the N-th polynomials having the coefficient Z_{q}. In detail, if n is Φ(N), the polynomial indicates a polynomial which may be calculated as the remainder of dividing the polynomial by an N-th cyclotomic polynomial. f(x) indicates ideal of Z_{q}[x] generated by f(x). The Euler totient function Φ(N) indicates the number of natural numbers that are prime to N and smaller than N. If Φ_{N}(X) is defined as the n-th cyclotomic polynomial, the ring may also be expressed as shown in Equation 3 below.

$$R = {Z}_{q} [ X ] / {Φ}_{N} ( x ) \qquad [ Equation 3 ]$$

If the ring is set in this way, the processor 130 may calculate the secret key sk from the ring.

$$sk ← ( 1 , s ( x ) ) , s ( x ) ∈ R \qquad [ Equation 4 ]$$

Here, s(x) indicates a random polynomial generated using a small coefficient.

In addition, if it is necessary to generate the ciphertext for the message, the processor 130 may generate the homomorphic ciphertext by applying the public key to the message.

If the ring and the secret key are selected, the processor 130 may calculate a first random polynomial a(x) from the ring. The first random polynomial may be expressed as follows.

$$a ( x ) ← R \qquad [ Equation 5 ]$$

In addition, the processor 130 may calculate the error. In detail, the processor 130 may extract the error from a discrete Gaussian distribution or a distribution having a statistical distance close thereto. This error may be expressed as follows.

$$e ( x ) ← {D}_{α q}^{n} \qquad [ Equation 6 ]$$

If even the error is calculated, the processor 130 may calculate a second random polynomial by performing the modular operations on the error in the first random polynomial and the secret key. The second random polynomial may be expressed as follows.

$$b ( x ) = - a ( x ) s ( x ) + e ( x ) ( mod q ) \qquad [ Equation 7 ]$$

Finally, a public key pk may be set to include the first random polynomial and the second random polynomial as follows.

$$pk = ( b ( x ) , a ( x ) ) \qquad [ Equation 8 ]$$

The key generation method described above is only an example, the present disclosure is not necessarily limited thereto, and the public key and the secret key may be generated using another method. In addition, the evaluation key may also be generated using the method described above.

If the public key is generated in this way, the processor 130 may generate the homomorphic ciphertext for the message by using the public key.

In addition, if the decryption is required for the homomorphic ciphertext, the processor 130 may apply the secret key to the homomorphic ciphertext to thus generate a polynomial-form decryption text, and generate the message by decoding the polynomial-form decryption text. The generated message here may include the error as mentioned in Equation 1 described above.

The processor 130 may convert the ciphertext. In detail, the processor 130 may perform the key switching. Here, the key switching may indicate an operation of exchanging the secret key for the ciphertext with another key without performing a decryption process of the ciphertext. For this key exchange, in the present disclosure, the derived public key derived from the public key and the session key may be used in a process of generating an initial ciphertext (i.e., ciphertext generated by the user device), or the session key used for encrypting the corresponding encrypted data may be transmitted and received together with a session key ciphertext, which is homomorphically encrypted, in a process of transmitting and receiving the public key and ciphertext.

Meanwhile, hereinabove, the method is used to convert the ciphertext, which is not the homomorphic ciphertext, into the homomorphic ciphertext. However, in implementation, the initial ciphertext may also be the homomorphic ciphertext. That is, both of a first ciphertext to be monitored and a second ciphertext, which is a key switching result, may be the homomorphic ciphertexts. In this case, the two ciphertexts may be the homomorphic ciphertexts using the same scheme. However, in implementation, the two ciphertexts may be the homomorphic ciphertexts using different schemes. If the schemes are different, the key switching described above may be referred to as multi-secret switching.

FIG. 4 is a diagram for explaining a monitoring method according to a first embodiment of the present disclosure.

Referring to FIG. 4, a decryption organization 300 may generate the secret key, the public key, the evaluation key, or the like, used for the homomorphic encryption, provide the public key and the evaluation key to the electronic apparatus 100, and provide the public key to each of the user devices 200.

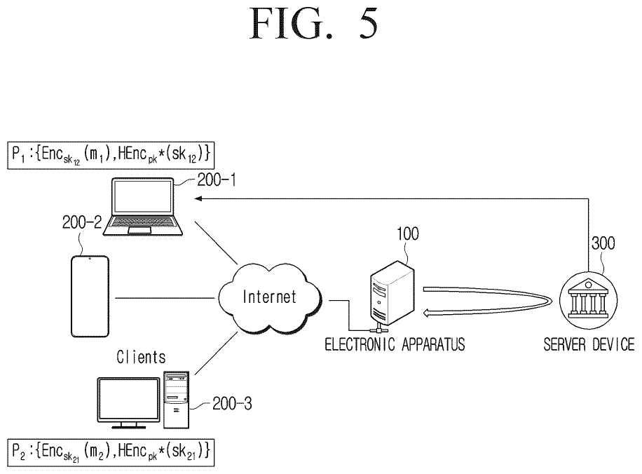

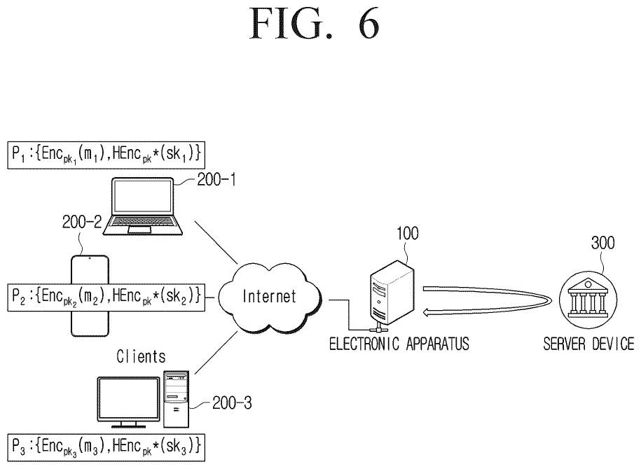

Each of the plurality of user devices 200 may receive the public key and set the session key to be used for communication with another device. Here, the plurality of user devices 200 may use the corresponding session key as an encryption key, or generate the derived public key by an operation with the received public key and use the generated derived public key as the encryption key. The former operation is described below with reference to FIG. 5, and the latter operation is described with reference to FIG. 6.

The electronic apparatus 100 may receive and store the public key (or the encryption key) and the evaluation key provided by the decryption organization 300. In addition, the electronic apparatus 100 may perform the key switching on the ciphertext acquired through the network by using the public key and the evaluation key described above, perform the predetermined homomorphic operation on the key switching result, and provide the same to the decryption organization 300.

The decryption organization 300 may decrypt the homomorphic ciphertext transmitted from the electronic apparatus 100 by using the prestored secret key and transmit the decryption result to the electronic apparatus 100.

FIG. 5 is a diagram for explaining a monitoring method according to a second embodiment of the present disclosure.

Referring to FIG. 5, the first user device 200-1 and the third user device 200-3 may generate a session key sk₁₂ or sk₂₁ (sk₁₂=sk₂₁) for mutual security communication. If the session key is generated in this way, each user device may encrypt the data to be transmitted using the session key. In addition, each user device may homomorphically encrypt the session key by using the received public key. The homomorphic encryption that is generated here may be referred to as the session key ciphertext (in detail, the session key homomorphic ciphertext).

The electronic apparatus 100 may acquire the first encrypted data encrypted using the session key and the session key ciphertext described above, and perform the key switching by the following operation.

$${SWK}_{{sk}_{ij} \to {pk}^{*}} \{ {Enc}_{{sk}_{ij}} ( {m}_{i} ) \} = {HEnc}_{{pk}^{*}} ( {m}_{i} ) = {ct}^{*} \qquad [ Equation 9 ]$$

Here, skᵢⱼ indicates the session key, pk* indicates the public key, SWK indicates a switching conversion operation, Enc indicates the encryption using the symmetric key method, and HEnc indicates the encryption using the homomorphic encryption method.

If the key switching is performed on the received first encrypted data in this way, the electronic apparatus 100 may perform the predetermined homomorphic operation on a corresponding result.

$$f ( {ct}^{*} ) = {HEnc}_{{pk}^{*}} \{ f ( {m}_{i} ) \} \qquad [ Equation 10 ]$$

The electronic apparatus 100 may transmit the homomorphic operation result described above to the server device 300.

The server device 300 may decrypt the received homomorphic ciphertext by using the secret key. In addition, the server device 300 may notify the electronic apparatus 100 of the decryption result. Here, the electronic apparatus 100 may transmit the data sender (that is, user information) together with the homomorphic operation result described above, and the server device 300 may transmit only the decryption result and the user information corresponding to a violator to the electronic apparatus 100.

The electronic apparatus 100, which receives the user information in this way, may perform the verification by transmitting an original ciphertext corresponding to the user information to the server device 300.

FIG. 6 is a diagram for explaining a monitoring method according to a third embodiment of the present disclosure.

In this case, each of the user devices may encrypt the data by using the generated derived public key. In addition, each of the user devices may transmit the session key ciphertext, which is generated by homomorphically encrypting the above-mentioned session key using the public key, in the transmission process of the encrypted data described above.

The electronic apparatus 100 may acquire the first encrypted data encrypted using the derived public key and the session key ciphertext described above, and perform the key switching by the following operation.

$${SWK}_{{sk}_{i} \to {pk}^{*}} \{ {Enc}_{{sk}_{i}} ( {m}_{i} ) \} = {HEnc}_{{pk}^{*}} ( {m}_{i} ) = {ct}^{*} \qquad [ Equation 11 ]$$

Here, skᵢ indicates the session key, pk* indicates the public key, SWK indicates the switching conversion operation, Enc indicates the encryption using the symmetric key method, and HEnc indicates the encryption using the homomorphic encryption method.

If the key switching is performed on the received first encrypted data in this way, the electronic apparatus 100 may perform the predetermined homomorphic operation on a corresponding result.

The electronic apparatus 100 may transmit the homomorphic operation result described above to the server device 300.

The server device 300 may decrypt the received homomorphic ciphertext by using the secret key. In addition, the server device 300 may notify the electronic apparatus 100 of the decryption result. Here, the electronic apparatus 100 may transmit the data sender (that is, the user information) together with the homomorphic operation result described above, and the server device 300 may transmit only the decryption result and the user information corresponding to the violator to the electronic apparatus 100.

The electronic apparatus 100, which receives the user information in this way, may perform the verification by transmitting the original ciphertext corresponding to the user information to the server device 300.

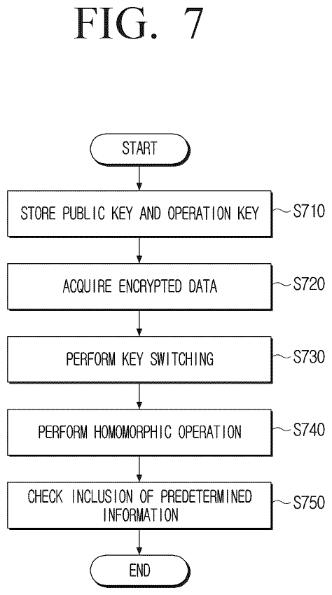

FIG. 7 is a diagram for explaining the monitoring method according to an embodiment of the present disclosure.

Referring to FIG. 7, the electronic apparatus may first store the public key generated using the homomorphic encryption method and the evaluation key used for the homomorphic operation (S710). Here, the public key may be generated based on the secret key that is generated in advance by the homomorphic encryption method, and the public key and the evaluation key may be generated based on the generated secret key. Meanwhile, the public key and the evaluation key described above may be generated by another electronic apparatus (for example, a verification organization), and the generated public key and evaluation key may be provided to the electronic apparatus 100 for use.

The electronic apparatus may acquire the first encrypted data transmitted and received through the network (S720). In detail, the electronic apparatus 100 may be connected to the network, and acquire the encrypted data by using the data transmitted and received through the network. Here, the electronic apparatus may acquire all the data transmitted and received through the network, or may acquire only the encrypted data for the data that meets the predetermined condition, such as the data transmitted from the specific IP address, the data transmitted to the specific IP address, or the data of the predetermined size or more. The encrypted data described above may be data transmitted by another electronic apparatus, and may be data encrypted using the session key. In this case, the electronic apparatus may acquire the session key ciphertext, which is generated by homomorphically encrypting the session key used for the encryption of the encrypted data, together with the encrypted data described above. Alternatively, the encrypted data described above may be the data encrypted using the derived public key that is generated by calculating the public key and the session key.

The electronic apparatus may generate the second encrypted data by using the first encrypted data, the public key, and the key switching method (S730). In detail, the electronic apparatus may convert the encrypted data into the second encrypted data capable of being decrypted using the secret key for the homomorphic ciphertext by using the key switching method corresponding to the encryption method by another electronic apparatus.

For example, the electronic apparatus may use the key switching method to generate the second encrypted data capable of being decrypted using the secret key corresponding to the public key by using the session key which is the decryption key for the first encrypted data, or may use the key switching method to generate the second encrypted data capable of being decrypted using the secret key corresponding to the public key by using the derived public key which is the decryption key for the first encrypted data.

The electronic apparatus may check whether the first encrypted data includes the predetermined information (S750) by performing the homomorphic operation corresponding to a predetermined detection function on the generated second encrypted data (S740). For example, the electronic apparatus may transmit the homomorphic ciphertext, on which the homomorphic operation is performed, to the external device having the secret key corresponding to the public key, and check whether the first encrypted data includes the predetermined information based on the verification result notified by the external device.

Here, in case of receiving the response that the predetermined information is included in the data, the electronic apparatus may transmit the first encrypted data to the external device, and use the plaintext data decrypted by the external device to thus verify the inclusion of the predetermined information.

As described above, in the method for monitoring a network according to this embodiment, the security violation situation or the like may be detected without performing the direct decryption on the transmitted and received data. In addition, the data in the encrypted state may be transmitted and received through the network in the above-described monitoring process, thus preventing the encrypted data from being disclosed. In addition, the electronic apparatus for the monitoring described above may also be operated without having the secret key for decrypting the homomorphic ciphertext, thus maintaining the security.

Meanwhile, the method for processing the ciphertext according to the various embodiments described above may be implemented in the form of a program code for performing each step, and distributed by being stored in a recording medium. In this case, a device mounted with the recording medium may perform the operations such as the encryption or the ciphertext processing described above.

The recording media may be various types of computer-readable media such as a read only memory (ROM), a random access memory (RAM), a memory chip, a memory card, an external hard drive, a hard drive, a compact disk (CD), a digital versatile disk (DVD), a magnetic disk, and a magnetic tape.

Although the present disclosure has been described hereinabove with reference to the accompanying drawings, the scope of the present disclosure is determined by the claims described below and should not be construed as being limited to the above-described embodiments or drawings. In addition, it should be clearly understood that improvements, changes, and modifications obvious to those skilled in the art of the present disclosure described in the claims are also included in the scope of the present disclosure.

What is claimed is:

1. An electronic apparatus comprising:
a communication device connected to a network;
a memory for storing a public key generated using a homomorphic encryption method and an evaluation key used for an homomorphic operation; and
a processor configured to
generate second encrypted data by using first encrypted data, the public key, and a key switching method if the first encrypted data transmitted and received through the network is acquired through the communication device, and
check whether the first encrypted data includes predetermined information by performing the homomorphic operation, which corresponds to a predetermined detection function, on the generated second encrypted data.

2. The apparatus as claimed in claim 1, wherein the processor is configured to
acquire the first encrypted data and a session key ciphertext, which is generated by homomorphically encrypting a session key used for encrypting the first encrypted data, the session key ciphertext being generated by homomorphically encrypting the session key using the public key, and
use the key switching method to generate the second encrypted data capable of being decrypted using a secret key corresponding to the public key by using the session key which is a decryption key for the first encrypted data.

3. The apparatus as claimed in claim 1, wherein the first encrypted data is data encrypted using a derived public key that is generated by calculating the public key and a session key, and
the processor is configured to
acquire the first encrypted data and a session key ciphertext, which is generated by homomorphically encrypting the session key using the public key, and
uses the key switching method to generate the second encrypted data capable of being decrypted using a secret key corresponding to the public key by using the derived public key which is a decryption key for the first encrypted data.

4. The apparatus as claimed in claim 1, wherein the first encrypted data is data encrypted using a symmetric key method, and
the second encrypted data is data homomorphically encrypted using a public key method.

5. The apparatus as claimed in claim 1, wherein the processor is configured to
control the communication device to transmit a homomorphic ciphertext, on which the homomorphic operation is performed, to an external device having a secret key corresponding to the public key, and
check whether the first encrypted data includes the predetermined information based on a verification result notified by the external device.

6. The apparatus as claimed in claim 5, wherein the processor is configured to
control the communication device to transmit the first encrypted data to the external device based on the verification result notified by the external device, and
verify the inclusion of the predetermined information by using plaintext data decrypted by the external device.

7. The apparatus as claimed in claim 1, wherein the processor is configured to
check whether the first encrypted data includes the predetermined information in the encrypted data transmitted to an internet protocol (IP) address other than a predetermined IP address in case of acquiring sender IP address information and receiver IP address information, corresponding to the first encrypted data.

8. A method for monitoring a network by an electronic apparatus, the method comprising:
pre-storing a public key generated using a homomorphic encryption method and an evaluation key used for an homomorphic operation;
acquiring first encrypted data transmitted and received through the network;
generating second encrypted data by using the first encrypted data, the public key, and a key switching method; and
checking whether the first encrypted data includes predetermined information by performing the homomorphic operation, which corresponds to a predetermined detection function, on the generated second encrypted data.

9. The method as claimed in claim 8, wherein in the acquiring, the first encrypted data and a session key ciphertext, which is generated by homomorphically encrypting a session key used for encrypting the first encrypted data, are acquired, the session key ciphertext being generated by homomorphically encrypting the session key using the public key, and
in the generating of the second encrypted data, the key switching method is used to generate the second encrypted data capable of being decrypted using a secret key corresponding to the public key by using the session key which is a decryption key for the first encrypted data.

10. The method as claimed in claim 8, wherein the first first encrypted data is data encrypted using a derived public key that is generated by calculating the public key and a session key,
in the acquiring, the first encrypted data and a session key ciphertext, which is generated by homomorphically encrypting the session key using the public key, are acquired, and
in the generating of the second encrypted data, the key switching method is used to generate the second encrypted data capable of being decrypted using a secret key corresponding to the public key by using the derived public key which is a decryption key for the first encrypted data.

11. The method as claimed in claim 8, wherein the first encrypted data is data encrypted using a symmetric key method, and
the second encrypted data is data homomorphically encrypted using a public key method.

12. The method as claimed in claim 8, wherein in the checking,
a homomorphic ciphertext, on which the homomorphic operation is performed, is transmitted to an external device having a secret key corresponding to the public key, and
whether the first encrypted data includes the predetermined information is checked based on a verification result notified by the external device.

13. The method as claimed in claim 12, further comprising:
transmitting the first encrypted data to the external device based on the verification result notified by the external device; and
verifying the inclusion of the predetermined information by using plaintext data decrypted by the external device.

14. The method as claimed in claim 8, wherein in the acquiring, sender IP address information and receiver IP address information, corresponding to the first encrypted data, are acquired, and
in the generating of the second encrypted data, whether the first encrypted data includes the predetermined information is checked in the encrypted data transmitted to an internet protocol (IP) address other than a predetermined IP address.

15. A non-transitory computer-readable recording medium storing a program for executing a method for monitoring a network by an electronic apparatus, wherein the method includes
pre-storing a public key generated using a homomorphic encryption method and an evaluation key used for an homomorphic operation,
acquiring first encrypted data transmitted and received through the network,
generating second encrypted data by using the first encrypted data, the public key, and a key switching method, and
checking whether the first encrypted data includes predetermined information by performing the homomorphic operation, which corresponds to a predetermined detection function, on the generated second encrypted data.
